(19) United States
(12) Patent Application Publication
(10) Pub. No.: US 2024/0378669 A1
(43) Pub. Date: Nov. 14, 2024

(54) BLOCKCHAIN-BASED CHARACTER TRADING APPARATUS AND METHOD

(71) Applicant: NEXON KOREA CORPORATION, Seongnam-si (KR)

(72) Inventors: Gihyuk RYU, Seongnam-si (KR); Daeun JEONG, Seongnam-si (KR)

(21) Appl. No.: 18/656,187

(22) Filed: May 6, 2024

(30) Foreign Application Priority Data
May 8, 2023 (KR) 10-2023-0059098

(51) Int. Cl. G06Q 40/04; A63F 13/77; A63F 13/792; G06Q 20/36; G06Q 20/38

(52) U.S. Cl. CPC G06Q 40/04; A63F 13/77; A63F 13/792; G06Q 20/3672; G06Q 20/389

(57) ABSTRACT

Described herein are a blockchain-based character trading apparatus and method. The blockchain-based character trading apparatus includes: memory; and a controller configured to configure and trade a character, acquired in a game, in the form of an electronic wallet based on a blockchain.

### CROSS-REFERENCE TO RELATED APPLICATION

This application claims the benefit of Korean Patent Application No. 10-2023-0059098 filed on May 8, 2023, which is hereby incorporated by reference herein in its entirety.

### BACKGROUND

### 1. Technical Field

The embodiments disclosed herein relate to a blockchain-based character trading apparatus and method, and more particularly to a blockchain-based character trading apparatus and method that configure and trade a character in the form of a wallet based on a blockchain.

### 2. Description of the Related Art

Blockchain technology is decentralized data processing technology that transparently records transaction details in ledgers that anyone can view and replicates and stores them across numerous computers.

This blockchain technology is being applied to and used in a variety of technical fields.

In one of them, a character in a game can be formed into a non-fungible token (NFT) based on a blockchain.

An NFT is a non-fungible token, and can prove that a work in question is a one-of-a-kind piece in the world. In this case, a digital art work is created by combining a digital medium and an NFT, and the trading of the work is made possible by registering and disclosing the trading of the NFT on a blockchain.

However, when a character in a game is simply configured and traded in the form of an NFT, the following problems may occur.

First, a change in the ownership of an item held by a character, i.e., the ownership of an NFT corresponding to the item, cannot be processed in a single transaction. Accordingly, for example, when a character in a game is simply configured and traded in the form of an NFT, a problem may arise in that the ownership of some items included in the character is changed and the ownership of other items is not changed.

Furthermore, the ownership of one or more items held by a character in a game may be changed by individually processing transactions for them. For example, in the case of a blockchain using a polygon network, there is a limit to the number of changes that can be made, as in the case where each user can change ownership less than about 100 times every two seconds. Accordingly, a problem may arise in that the ownership of items cannot be changed smoothly.

As described above, in order to overcome the problem in which it is impossible to change ownership through a single transaction or there is a limit to the number of changes in ownership due to a structural problem of a blockchain, blockchain-based games employ a method in which only a predetermined number of items can be packaged with a character and then traded or all of a user's assets (for example, characters and items traded on a blockchain) are managed by a system from the beginning. However, when only a predetermined number of items are packaged with a character and then traded, a problem may arise in that the load on a system increases because a transaction for trading needs to be re-generated when another item is equipped. Meanwhile, when all of the user's assets are managed by the system, a problem may arise in that the administrator of the system may manipulate the user's assets.

Therefore, there is a need for research into technology that can overcome the above-described problems.

Meanwhile, the above-described background technology corresponds to the technical information that has been possessed by the present inventor in order to contrive the present invention or that has been acquired in the process of contriving the present invention, and can not necessarily be regarded as well-known technology that had been known to the public prior to the filing of the present invention.

### RELATED ART LITERATURE

Patent Document 1: Korean Patent No. 10-2465842 (published on Nov. 10, 2022)

### SUMMARY

An object of the embodiments disclosed herein is to propose a blockchain-based character trading apparatus and method.

An object of the embodiments disclosed herein is to propose a blockchain-based character trading apparatus and method that configure and trade a character in the form of an electronic wallet based on a blockchain.

As a technical solution for accomplishing the above objects, according to an embodiment, there is provided a blockchain-based character trading apparatus, including: memory; and a controller configured to configure and trade a character, acquired in a game, in the form of an electronic wallet based on a blockchain.

According to another embodiment, there is provided a blockchain-based character trading method, the blockchain-based character trading method being performed by a blockchain-based character trading apparatus, the blockchain-based character trading method including: acquiring a character in a game; and configuring and trading the character in the form of an electronic wallet based on a blockchain.

According to another embodiment, there is provided a non-transitory computer-readable storage medium having stored thereon a program that, when executed by a processor, causes the processor to execute a blockchain-based character trading method. The blockchain-based character trading method includes: acquiring a character in a game; and configuring and trading the character in the form of an electronic wallet based on a blockchain.

According to another embodiment, there is provided a computer program that is executed by a blockchain-based character trading apparatus and stored in a non-transitory computer-readable storage medium to perform a blockchain-based character trading method. The blockchain-based character trading method includes: acquiring a character in a game; and configuring and trading the character in the form of an electronic wallet based on a blockchain.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram showing a blockchain-based character trading apparatus according to an embodiment; and

FIG. 2 is a flowchart illustrating a blockchain-based character trading method according to an embodiment.

### DETAILED DESCRIPTION

Various embodiments will be described in detail below with reference to the accompanying drawings. The following embodiments may be modified and practiced in various different forms. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component disposed therebetween.” Furthermore, when one component is described as “including” another component, this does not mean that the one component does not exclude a third component but means that the one component may further include a third component, unless explicitly described to the contrary.

Embodiments will be described in detail below with reference to the accompanying drawings.

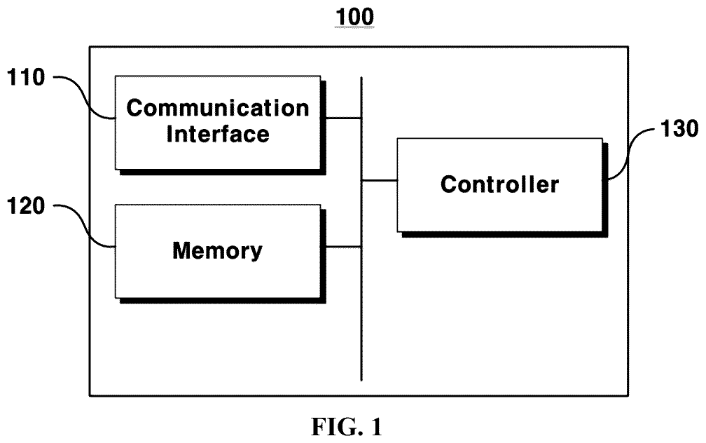

FIG. 1 is a block diagram showing a blockchain-based character trading apparatus according to an embodiment.

The character trading apparatus 100 shown in FIG. 1 is an apparatus that trades content information, provided by a game providing apparatus (not shown), according to a character trading method, and may be included in the game providing apparatus or include the game providing apparatus. When the character trading apparatus 100 is implemented as an apparatus separate from the game providing apparatus, it may transmit and receive information for the performance of a character trading method while communicating with the game providing apparatus. In this case, the content information according to an embodiment may be a character used in a game and information about an asset corresponding to the character, and the information about an asset may be, e.g., an item held by or equipped to the character.

The character trading apparatus 100 may be implemented as an electronic terminal equipped with an application that can interact with a game user, or may be implemented as a server-client system. When the character trading apparatus 100 may be implemented as a server-client system, it may include an electronic terminal for interaction with a game user.

In this case, the electronic terminal may be implemented as a computer, a mobile terminal, a television, a wearable device, or the like that can access a remote server or connect with another terminal and a server over a network. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or connect with another terminal directly or via another information processing device over a network.

Furthermore, the server may be implemented as a computer capable of communicating with an electronic terminal over a network, or may be implemented as a cloud computing server.

As described above, the character trading apparatus 100 may be implemented in the form of any one of an electronic terminal, a server, and a server-client system.

The character trading apparatus 100 according to an embodiment may include a communication interface 110, memory 120, and a controller 130.

Meanwhile, the communication interface 110 may perform wired/wireless communication with another device or a network. For example, the communication interface 110 may communicate with a third server to transmit and receive various types of information for the performance of a character trading method. To this end, the communication interface 110 may include a communication module configured to support at least one of various wired/wireless communication methods. For example, the communication module may be implemented in the form of a chipset.

The wireless communication supported by the communication interface 110 may be, e.g., Wireless Fidelity (Wi-Fi), Wi-Fi Direct, Bluetooth, Ultra-Wide Band (UWB), or Near Field Communication (NFC). Furthermore, the wired communication supported by the communication interface 110 may be, e.g., Universal Serial Bus (USB), or High Definition Multimedia Interface (HDMI).

According to the embodiment, when the character trading apparatus 100 is configured as a server, the communication interface 110 may receive a game user's input from an electronic terminal used by the game user, and may also transmit calculation results according to the performance of the character trading method to the electronic terminal used by the game user.

Various types of data, such as files, applications, and programs, may be installed and stored in the memory 120. The controller 130, which will be described later, may access and use the data stored in the memory 120, or may store new data in the memory 120. Furthermore, the controller 130 may execute a program installed in the memory 120. For example, the memory 120 may allow a program for the performance of a character trading method to be installed thereon, and may also store various types of information for the performance of the character trading method as described above.

The controller 130 may control the overall operation of the character trading apparatus 100 and include a processor such as a CPU, a GPU, and/or the like. The controller 130 may control other components included in the character trading apparatus 100 to perform an operation corresponding to a user's input. For example, the controller 130 may execute a program stored in the memory 120, read a file stored in the memory 120, or store a new file in the memory 120.

The controller 130 may configure and trade a character, acquired in a game, in the form of an electronic wallet based on a blockchain. In this case, acquiring a character may mean creating the character in the game, or making the character appear in the game through a game activity such as the creation of an account, the success of a quest, or a purchase. Accordingly, for example, when a character is assigned to a user account as soon as the game account is created, the character may be considered to have been acquired by a user. Meanwhile, configuring a character in the form of an electronic wallet based on a blockchain may mean creating a contract account (CA) managed by a smart contract. In this case, when a character is acquired, the character itself is configured in the form of an electronic wallet, making it possible to deposit and withdraw an item, held by the character, as an asset. In this case, depositing items owned by a character as assets may mean putting items into an electronic wallet, and withdrawing items owned by a character as assets may mean taking out items from an electronic wallet. A CA may function like a wallet on a blockchain, accordingly allowing the assets to be deposit and withdrawn, that is, the character may be the owner of the assets. Generally, in an Ethereum blockchain, an asset is managed through an external owned account (EOA), which manages a combination of an address (a public key) and a private key as an account. In contrast, according to the present invention described above, the character acquired in the game is configured in the form of an electronic wallet by creating a CA managed by a smart contract, and the asset included in the character is managed. Accordingly, a CA-based electronic wallet may provide higher security and convenience than an EOA-based electronic wallet. In other words, a smart contract records contract conditions on a blockchain and automatically executes the contract when the conditions are met, so that a CA-based electronic wallet managed by a smart contract can provide higher security and convenience than an EOA-based electronic wallet. Furthermore, when the character is traded (sold), the identification information of a user who sold the character is changed into the identification information of a user who purchased the character, and the owner information (owner) of an NFT corresponding to the character is also changed. Accordingly, the ownership of the character is changed, and also the ownership of the asset included in the character may also be changed automatically without a separate transaction. In other words, when only the ownership of a character itself is changed, the ownership of an asset included in the character, i.e., an asset belonging to the character, may also be naturally changed. According to an embodiment, an NFT created based on a character may allow owner information (an owner) to be mapped thereto. In this case, when the character is traded, the controller 130 may change the owner of the NFT corresponding to the character from the user who sold the character to the user who purchased the character. For example, when the identification information of the user who sold the character is ‘a017’ and the identification information of the user who purchased the character is ‘b123,’ the owner of the NFT corresponding to the character may be changed to ‘b123’, which is the identification information of the user who purchased the character.

Meanwhile, when the owner of the NFT corresponding to the character is changed, the owner of the electronic wallet may also be changed. For example, when the owner of the NFT corresponding to the character is changed from ‘a017’ to ‘b123,’ the owner of the electronic wallet may also be automatically changed. As will be described later, when a character is configured in the form of an electronic wallet, NFT minting and a contract account are created together, and an NFT created based on the character and the contract account are linked to each other. Accordingly, when the character is traded, the ownership information of the NFT of the character is changed from a user who sold the character to a user who purchased the character. In this case, based on the changed ownership information, it may be possible to determine the owner of the NFT, and accordingly, it may be possible to automatically determine the owner of the contract account linked to the NFT of the character. Therefore, it may be possible to determine the owner of a changed electronic wallet. That is, the owner of the electronic wallet may be identified based on the ownership information (the owner) of the NFT mapped to the contract account. In other words, the owner of the electronic wallet may be identified by using the ownership information (the owner) of the NFT linked to the contract account as a key value that identifies an owner. In this manner, in the present invention, when a character is traded, the contract account information itself is not changed, but the ownership information of the NFT of the character is changed, so that the owner of the NFT can be identified based on the changed ownership information. Accordingly, it may be determined who holds the contract account linked to the NFT of the character. Additionally, a character may hold various assets. When the ownership information (the owner) of an NFT created based on the character is changed, the ownership information (the owner) of the assets held by the character may be automatically changed without the performance of a separate transaction. For example, when character ‘A’ is traded in the case where character ‘A’ holds assets such as a ‘spear’ and a ‘shield,’ the ownership information of character ‘A’ is changed from ‘a017’ to ‘b123,’ so that the ownership information (the owner) of the assets such as the ‘spear’ and ‘shield’ held by character ‘A’ may also be automatically changed from ‘a017’ to ‘b123.’

Meanwhile, when a character is configured in the form of an electronic wallet, the controller 130 may create NFT minting and a CA together.

The NFT minting refers to the issuance of an NFT. According to an embodiment, the NFT minting may be the creation of the NFT of a character that constitutes an electronic wallet. In this case, the NFT may refer to an identification number that can identify the character. In this case, the identification number is a token having a unique value. The NFT is a digital asset that can prove the ownership of an owner. Any one token cannot be replaced by another token. According to an embodiment, the NFT of the character may be created by creating an identification number intended to identify the character as identification information, transmitting the created identification information to a preset external blockchain network, and requesting the issuance of the NFT based on the identification information. Meanwhile, the NFT created based on the character is mapped to ownership information, i.e., an owner. In other words, the NFT created based on the character is mapped to ownership information. As described above, first ownership information for the NFT created based on the character, i.e., the owner, may be mapped to the identification information of a user who requested to configure the character as an electronic wallet when the character is configured in the form of an electronic wallet.

In this case, as described above, the NFT minting and the CA are created together, so that the CA and the NFT created based on the character are linked to each other. Accordingly, when the character is traded, the ownership information of the NFT corresponding to the character may be changed, and the owner of the CA may be automatically identified by determining the owner based on the changed ownership information.

As described above, the asset included in the character constituting the electronic wallet may be deposited and withdrawn because NFT minting is created also when the character is configured in the form of an electronic wallet. Accordingly, the ownership of the asset for which an NFT is created by NFT minting may be registered with the character configured in the form of an electronic wallet. In other words, a user who has the ownership of the electronic wallet may also have the ownership of the asset for which the NFT is created by the NFT minting.

Thereafter, when the character is traded, the owner of the NFT corresponding to the character may be changed from a user who sold the character to a user who purchased the character. For example, when the identification information of the user who sold the character is ‘a017’ and the identification information of the user who purchased the character is ‘b123,’ the ownership information of the character assigned to the electronic wallet is changed by changing the owner, mapped to the NFT corresponding to the character, to ‘b123,’ which is the identification information of the user who purchased the character. Accordingly, the user who purchased the character may automatically obtain the ownership of one or more assets held by the user who sold the character without creating a separate transaction intended to change the ownership of the assets held by the character.

In other words, as a character is created in the form of an electronic wallet, various assets held by the character may be deposited and withdrawn. Accordingly, when the ownership of the character configured in the form of the electronic wallet is changed, the ownership of an asset held by the character may be automatically changed without a separate change. In other words, the owner of the character may be registered as the owner of various assets held by the character.

Furthermore, as described above, the overall information generated as a character is traded is included in a block, and blocks can be connected in chronological order to form a chain structure, thereby forming a blockchain. Accordingly, the trading transparency of a character may be guaranteed. Information about the trading history of the character is distributed, so that the forgery and falsification of the information is difficult, which provides the advantage of excellent security.

When a character is traded, the controller 130 may trade the character by changing the ownership information of an NFT corresponding to the character. In this case, the owner of the NFT corresponding to the character may be identified by determining ownership information that is mapped to the NFT corresponding to the character. Since NFT minting and a CA are created together, the CA and an NFT corresponding to the character are linked to each other, so that it can be determined that the owner of the CA has been also automatically changed by determining the ownership information of the NFT corresponding to the character, i.e., the owner of the NFT.

As described above, when a character is traded, the ownership information of an NFT corresponding to the character may be changed from a user who sold the character to a user who purchased the character. Accordingly, the ownership information of the character assigned to an electronic wallet may be changed. Therefore, the user who purchased the character may automatically obtain the ownership of one or more assets held by the user who sold the character without creating a separate transaction intended to change the ownership of the assets held by the character.

Meanwhile, a variable may be added by taking into consideration the fact that there may arise a case where a character is sold while a game is being played. In other words, it is difficult to immediately reflect game results in a blockchain. Accordingly, when the ownership of the character is transferred to another user while the owner of the character is playing a game using the character he or she holds, a problem arises in that the change in the ownership is not reflected in the game in real time. In order to overcome this problem, it may be necessary to determine whether the character is in an in-game state. As for this, it may be determined whether the character is in an in-game state by checking a variable stored in a ‘Character SmartContract’ assigned to each character. In this case, the Character SmartContract may be recorded on a blockchain. Depending on the state value of the variable stored in the Character SmartContract, it can be determined whether the character is in an in-game state. For example, the variable may be declared as “isExported,” and the state value of the corresponding variable may be either true or false. More specifically, when a user purchases a character at an exchange, the state value of the variable of the Character SmartContract may be true, and this may be recorded in a blockchain. In this case, as the state value of the variable of the Character SmartContract is true, it may be determined that the character is not in an in-game state, and it may be determined that the character can be traded. Meanwhile, when a user who purchased the character wants to use the character in a game, he or she may click a user interface intended to change the state value of the variable. In this case, the controller 130 may change the state value of the variable stored in the Character SmartContract recorded on the blockchain from true to false and record it on the blockchain. Through this, the controller 130 may indicate that the character is in-game (i.e., the character is being used to play the game) and it is difficult to trade the character. Furthermore, when a user wants to sell his or her in-game character, he or she needs to change the state value of the variable stored in the Character SmartContract. In other words, when the character is in-game, the state value of the variable of the Character SmartContract is false, so that the user who wants to sell the character can click the user interface intended to change the state value of the variable to sell the character. In this case, the controller 130 may change the state value of the variable stored in the Character SmartContract recorded on the blockchain from false to true and record it.

According to an embodiment, the character trading apparatus 100 may further include an input/output interface (not shown).

The input/output interface may include an input interface configured to receive input from a game user, and an output interface configured to display information such as the performance results of a task or the state of the character trading apparatus 100. For example, the input/output interface may include an operation panel configured to receive input from a game user, and a display panel configured to display screens.

More specifically, the input interface may include various types of devices capable of receiving input, such as a keyboard, physical buttons, a touch screen, a camera, and a microphone. Furthermore, the output interface may include a display panel, and a speaker. However, the input/output interface is not limited thereto, but may include various types of components capable of supporting input or output.

According to an embodiment, the input interface may receive input regarding the operation of a game from a game user while the game is in progress, and may also receive input regarding the trading of a character. Furthermore, the output interface may output and provide the results of calculations according to the operations of a user. According to an embodiment, the output interface may output and provide screens configured to check the transfer of ownership of a character or a character and/or an asset held through the transfer of ownership.

According to the foregoing description, a character is configured and traded in the form of an electronic wallet based on a blockchain, so that one or more assets held by the character can be deposited and withdrawn. The ownership of the assets held by the character may also be changed automatically, by changing the ownership of the character, so that there is no need for a separate transaction intended to change the ownership of the assets held by the character, which provides the advantage of preventing the load of the system from increasing.

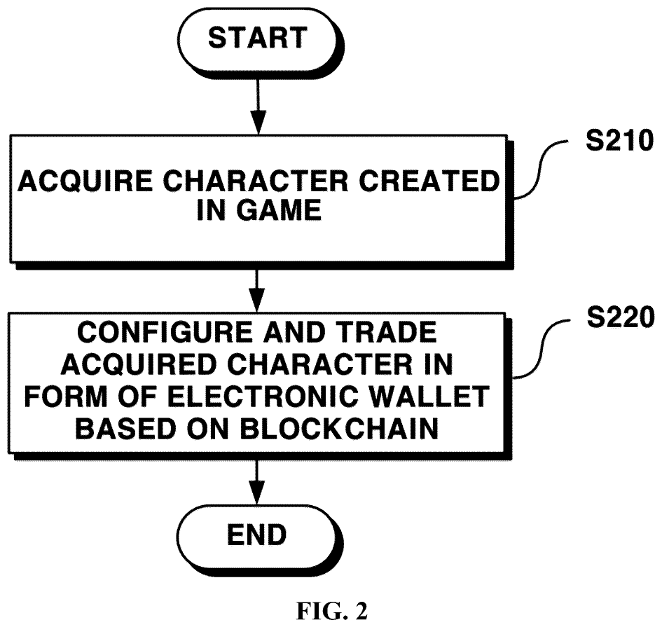

Meanwhile, FIG. 2 is a flowchart illustrating a character trading method according to an embodiment. The character trading method shown in FIG. 2 includes steps that are processed in a time-series manner in the character trading apparatus 100 shown in FIG. 1. Accordingly, the descriptions that are omitted below but have been given above in conjunction with the character trading apparatus 100 shown in FIG. 1 may also be applied to the character trading method according to the embodiment shown in FIG. 2.

As shown in FIG. 2, the character trading apparatus 100 according to an embodiment may acquire a character created in a game in step S210.

Thereafter, the character trading apparatus 100 may configure and trade the character, acquired in step S210, in the form of an electronic wallet based on a blockchain in step S220. The character trading apparatus 100 may create NFT minting and a CA together when configuring the character in the form of an electronic wallet. In this case, the NFT minting refers to the issuance of an NFT. According to an embodiment, the NFT minting may be the creation of the NFT of a character that constitutes an electronic wallet. In this case, the NFT may refer to an identification number that can identify the character. In this case, the identification number is a token having a unique value. The NFT is a digital asset that can prove the ownership of an owner. Any one token cannot be replaced by another token. According to an embodiment, the NFT of the character may be created by creating an identification number adapted to identify the character as identification information, transmitting the created identification information to a preset external blockchain network, and requesting the issuance of the NFT based on the identification information. Meanwhile, the NFT created based on the character is mapped to ownership information, i.e., an owner. In other words, the NFT created based on the character is mapped to ownership information. As described above, first ownership information for the NFT created based on the character, i.e., the owner, may be mapped to the identification information of a user who requested it when the character is configured in the form of an electronic wallet. In this case, as described above, the NFT minting and the CA are created together, so that the CA and an NFT created based on the character are linked to each other. Accordingly, when the character is traded, the ownership information of the NFT corresponding to the character may be changed, and the owner of the CA may be automatically identified by determining the owner based on the changed ownership information.

When a character is traded, the character trading apparatus 100 may trade the character by changing the ownership information of an NFT corresponding to the character. In this case, the owner of the NFT corresponding to the character may be identified by determining ownership information that is mapped to the NFT corresponding to the character. Since NFT minting and a CA are created together, the CA and an NFT corresponding to a character are linked to each other, so that it can be determined that the owner of the CA has been also automatically changed by determining the ownership information of the NFT corresponding to the character, i.e., the owner of the NFT. As described above, when a character is traded, the ownership information of an NFT corresponding to the character may be changed from a user who sold the character to a user who purchased the character. Accordingly, the ownership information of the character assigned to an electronic wallet may be changed. Therefore, the user who purchased the character may automatically obtain the ownership of one or more assets held by the character of the user who sold the character without creating a separate transaction intended to change the ownership of the assets held by the character.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

The functions provided in components and “unit(s)” may be combined into a smaller number of components and “unit(s)” or divided into a larger number of components and “unit(s).”

In addition, components and “unit(s)” may be implemented to run one or more central processing units (CPUs) in a device or secure multimedia card.

The character trading method according to the embodiment described in conjunction with FIG. 2 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the character trading method according to the embodiment described in conjunction with FIG. 2 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the character trading method according to the embodiment described in conjunction with FIG. 2 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to some of the above-described solutions, there are proposed the blockchain-based character trading apparatus and method.

According to some of the above-described solutions, one or more assets (e.g., one or more items) held by a character may be deposited and withdrawn by configuring and trading the character in the form of a wallet based on a blockchain, and thus, the ownership of the assets included in the character may also be automatically changed by changing the ownership of the character itself, so that there is no need for a separate transaction (or an additional transaction) intended to change the ownership of the assets included in the character, which provides the advantage of preventing an increase in system load.

The advantages that can be achieved by the embodiments disclosed herein are not limited to the advantage described above, and other advantages not described above will be clearly understood by those having ordinary skill in the art, to which the embodiments disclosed herein pertain, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A blockchain-based character trading apparatus, comprising:
memory; and
a controller configured to configure and trade a character, acquired in a game, in a form of an electronic wallet based on a blockchain.

2. The blockchain-based character trading apparatus of claim 1, wherein the controller creates non-fungible token (NFT) minting and a contract account together when configuring the character in the form of the electronic wallet.

3. The blockchain-based character trading apparatus of claim 2, wherein the NFT minting is creating an NFT corresponding to the character that constitutes the electronic wallet.

4. The blockchain-based character trading apparatus of claim 2, wherein an owner of the electronic wallet is identified based on ownership information of an NFT mapped to the contract account.

5. The blockchain-based character trading apparatus of claim 2, wherein, when the character is traded, the controller trades the character by changing ownership information of an NFT corresponding to the character.

6. A blockchain-based character trading method, the blockchain-based character trading method being performed by a blockchain-based character trading apparatus, the blockchain-based character trading method comprising:
acquiring a character in a game; and
configuring and trading the character in a form of an electronic wallet based on a blockchain.

7. The blockchain-based character trading method of claim 6, wherein configuring and trading the character comprises creating non-fungible token (NFT) minting and a contract account together when configuring the character in the form of the electronic wallet.

8. The blockchain-based character trading method of claim 7, wherein the NFT minting is creating an NFT corresponding to the character that constitutes the electronic wallet.

9. The blockchain-based character trading method of claim 7, wherein an owner of the electronic wallet is identified based on ownership information of an NFT mapped to the contract account.

10. The blockchain-based character trading method of claim 7, wherein configuring and trading the character comprises, when the character is traded, trading the character by changing ownership information of an NFT corresponding to the character.

11. A non-transitory computer-readable storage medium having stored thereon a program that, when executed by a processor, causes the processor to execute the blockchain-based character trading method set forth in claim 6.

12. A computer program that is executed by a blockchain-based character trading apparatus and stored in a non-transitory computer-readable storage medium to perform the blockchain-based character trading method set forth in claim 6.
